(19) United States
(12) Patent Application Publication
(10) Pub. No.: US 2015/0085073 A1
(43) Pub. Date: Mar. 26, 2015

(54) QUALITY METRIC FOR PROCESSING 3D VIDEO

(71) Applicant: KONINKLIJKE PHILIPS N.V., EINDHOVEN (NL)

(72) Inventors: Wilhelmus Hendrikus Alfonsus Bruls, Eindhoven (NL); Bartolomeus Wilhelmus Damianus Sonneveldt, Eindhoven (NL)

(21) Appl. No.: 14/397,404

(22) PCT Filed: May 2, 2013
(86) PCT No.: PCT/IB2013/053461

§ 371 Date: Oct. 27, 2014

Related U.S. Application Data
(60) Provisional application No. 61/641,352, filed on May 2, 2012.

(51) Int. Cl. H04N 13/00

(52) U.S. Cl. CPC H04N 13/0011; H04N 13/0022
USPC 348/43

(57) ABSTRACT

A 3D video device (50) processes a video signal (41) that has at least a first image to be displayed on a 3D display. The 3D display (63) requires multiple views for creating a 3D effect for a viewer, such as an autostereoscopic display. The 3D video device has a processor (52) for determining a processed view based on the 3D image data adapted by a parameter for targeting the multiple views to the 3D display, and calculating a quality metric indicative of perceived 3D image quality. The quality metric is based on a combination of image values of the processed view and a further view. A preferred value for the parameter is determined based on repeatedly determining and calculating using different values. Advantageously, the quality metric predicts the perceived image quality based on a combination of image content and disparity.

### FIELD OF THE INVENTION

The invention relates to a 3D video device for processing a three dimensional [3D] video signal. The 3D video signal comprises at least a first image to be displayed on a 3D display. The 3D display requires multiple views for creating a 3D effect for a viewer. The 3D video device comprises a receiver for receiving the 3D video signal.

The invention further relates to a method of processing a 3D video signal.

The invention relates to the field of generating and/or adapting views based on the 3D video signal for a respective 3D display. When content is not intended for playback on a specific autostereoscopic device, the disparity/depth in the image may need to be mapped onto a disparity range of the target display device.

### BACKGROUND OF THE INVENTION

The document “A Perceptual Model for disparity, by p. Didyk et al, ACM Transactions on Graphics, Proc. of SIGGRAPH, year 2011, volume 30, number 4” provides a perceptual model for disparity and indicates that it can be used for adapting 3D image material for specific viewing conditions. The paper describes that disparity contrasts are more perceptively noticeable and provides a disparity difference metric for retargeting. The disparity difference metric is based on analyzing images based on the disparity differences to determine the amount of perceived perspective. A process of adapting a 3D signal for different viewing conditions is called retargeting and global operators for retargeting are discussed, the effect of retargeting being determined based on the metric (e.g. in section 6, first two paragraphs, and section 6.2).

### SUMMARY OF THE INVENTION

The known difference metric is rather complex and requires disparity data to be available for analysis.

It is an object of the invention to provide a system for providing a parameter for targeting a 3D video signal to a respective 3D display based on a quality metric that is less complex while optimizing the perceived 3D image quality of a respective 3D display.

For this purpose, according to a first aspect of the invention, the device as described in the opening paragraph comprises a processor for determining at least one processed view based on the 3D image data adapted by a parameter for targeting the multiple views to the 3D display, calculating a quality metric indicative of perceived 3D image quality, which quality metric is based on a combination of image values of the processed view and a further view, and determining a preferred value for the parameter based on performing said determining and calculating for multiple values of the parameter.

The method comprises receiving the 3D video signal, determining at least one processed view based on the 3D image data adapted by a parameter for targeting the multiple views to the 3D display, calculating a quality metric indicative of perceived 3D image quality, which quality metric is based on a combination of image values of the processed view and a further view, and determining a preferred value for the parameter based on performing said determining and calculating for multiple values of the parameter.

The measures have the effect that device receives a 3D video signal and determines a parameter for adapting views for the respective display to enhance the quality of the 3D image as displayed by the respective 3D display for a viewer. The process of adapting views for a particular display is called targeting the views for the 3D display. For example, the particular display may have a limited depth range for high quality 3D images. For example a gain parameter may be determined for applying to the depth values used for generating or adapting the views for such display. In a further example the respective display may have a preferred depth range, usually near the display screen that has a high sharpness, whereas 3D objects protruding towards the viewer tend to be less sharp. An offset parameter may be applied to the views to control the amount of disparity, and subsequently the 3D objects may be shifted towards the high sharpness, preferred depth range. Effectively the device is provided with an automatic system for adjusting said parameter for optimizing the 3D effect and perceived image quality of the respective 3D display. In particular the quality metric is calculated based on the combination of image values to determine the perceived 3D image quality and is used to measure the effect of multiple different values of the parameter on the 3D image quality.

The invention is also based on the following recognition. Traditionally the adjustment of the views for the respective 3D display may be performed manually by the viewer based on his judgment of the 3D image quality. Automatic adjustment, e.g. based on processing a depth or disparity map by gain and offset to map the depths into a preferred depth range of the respective 3D display, may result in images getting blurred for certain parts and/or a relatively small depth effect. The inventors have seen that such mapping tends to be biased by relatively large objects having a relatively large disparity, but a relatively low contribution to perceived image quality, such as remote clouds. The proposed quality metric is based on comparing image values of the combination of image values of the processed view that contains image data warped by disparity and image values of the further view, for example an image that is provided with the 3D video signal. The image values of the combination represent both the image content and the disparity in the views as disparity is different in both views. Effectively objects that have high contrasts or structure do contribute substantially to the quality metric, whereas objects having few perceivable characteristics do hardly contribute in spite of large disparity.

When the image metric is used to optimize parameters impacting the on-screen disparity of rendered images it is important to relate image information from different views. Moreover in order to best relate these views, the image information compared is preferably from the corresponding x,y position in the image. More preferably this involves re-scaling input and rendered image such that their image dimensions match, in which case the same x,y position can be matched.

Advantageously, by using the combination of image values of the further view and the processed view for calculating the metric a measure has been found that corresponds to the perceived image quality. Moreover, the proposed metric does not require that disparity data or depth maps as such are provided or calculated to determine the metric. Instead, the metric is based on the image values of the processed image, which are modified by the parameter, and the further view.

Optionally, the further view is a further processed view based on the 3D image data adapted by the parameter. The further view represents a different viewing angle, and is processed by the same value of the parameter, e.g. offset. The effect is that at least two processed views are compared and the quality metric represents the perceived quality due to the differences between the processed views.

Optionally, the further view is a 2D view available in the 3D image data. The effect is that the processed view is compared to an original 2D view that has a high quality and no artifacts due to view warping.

Optionally, the further view is a further processed view based on the 3D image data adapted by the parameter and the processed view and the further processed view are interleaved to constitute the combination of image values. The processed view may correspond to an interleaved 3D image to be displayed on an array of pixels of an auto stereoscopic 3D display by interleaving the multiple views. The interleaved 3D image is constructed by assembling a combined matrix of pixels to be transferred to a display screen, which is provided with optics to accommodate different, adjacent views in different directions so that such different views are perceived by the respective left and right eyes of viewers. For example the optics may be a lenticular array for constituting an autostereoscopic display (ASD) as disclosed in EP 0791847A1.

EP 0791847A1 by the same Applicant shows how image information associated with the different views may be interleaved for a lenticular ASD. As can be seen in the figures of EP 0791847A1, the respective subpixels of the display panel under the lenticular (or other light directing means) are assigned view numbers; i.e. they care information associated with that particular view. The lenticular (or other light directing means) overlaying the display panel subsequently directs the light emitted by the respective subpixels to the eyes of an observer, thereby providing the observer with pixels associated a first view to the left eye and a second view to the right eye. As a result the observer will, provided that proper information is provided in the first and second view image, perceive a stereoscopic image.

As disclosed in EP 0791847A1 pixels of different views are interleaved, preferably at the subpixel level when looking at the respective R, G and B values of a display panel. Advantageously, the processed image is now similar to the interleaved image that has to be generated for the final 3D display. The quality metric is calculated based on the interleaved image, e.g. by determining a sharpness of the interleaved image.

Optionally, the processor is arranged for determining at least a first view and a second view based on the 3D image data adapted by the parameter, and interleaving the at least first and second view to determine the processed view. The interleaved view is compared to the further view, e.g. a 2D image as provided in the 3D video signal.

Optionally, the processor is arranged for determining the processed view based on a leftmost and/or a rightmost view, the multiple views forming a sequence of views extending from the leftmost view to the rightmost view. Advantageously, the leftmost and/or rightmost view contain relatively high disparity with respect to the further view.

Optionally, the processor is arranged for calculating the quality metric based on a Peak Signal-to-Noise Ratio calculation on the combination of image values, or based on a sharpness calculation on the combination of image values. The Peak Signal-to-Noise Ratio (PSNR) is the ratio between the maximum possible power of a signal and the power of corrupting noise that affects the fidelity of its representation. The PSNR now provides a measure of perceived quality of 3D image.

Optionally in the 3D device the parameter for targeting the 3D video comprises at least one of an offset; a gain; or a type of scaling. The preferred value of such parameter is applied for targeting the views for the 3D display as a processing condition for adapting the warping of views. The offset, when applied to the views, effectively moves objects back or forth with respect to the plane of the display. Advantageously a preferred value for the offset moves important objects to a position near the 3D display plane. The gain, when applied to the views, effectively moves objects away or towards the plane of the 3D display. Advantageously, a preferred value for the gain moves important objects with respect to the 3D display plane. The type of scaling indicates how the values in the views are modified into actual values when warping the views, e.g. bi-linear scaling, bicubic scaling, or how to adapt the viewing cone.

Optionally, the processor is arranged for calculating the quality metric based on a central area of the combination of image values by ignoring border zones. The border zones may be disturbed, or incomplete due to the adapting by the parameter, and usually do not contain relevant high disparity values or protruding objects. Advantageously the metric, when only based on the central area, is more reliable.

Optionally, the processor is arranged for calculating the quality metric by applying a weighting on the combination of image values in dependence on corresponding depth values. Differences between the image values are further weighted by local depths, e.g. protruding objects that have more impact on perceived quality may be stressed to have more contribution to the quality metric.

Optionally, the processor is arranged for determining a region of interest in the processed view, and for calculating the quality metric by applying a weighting on the combination of image values in the region of interest. In the region of interest differences between the image values are weighted for calculating the quality metric. The processor may have a face detector for determining the region of interest.

Optionally, the processor is arranged for calculating the quality metric for a period of time in dependence of a shot in the 3D video signal. Effectively the preferred value of the parameter applies to a period of the 3D video signal that has a same 3D configuration, e.g. a specific camera and zoom configuration. Usually the configuration is substantially stable during a shot of a video program. Shot boundaries may be known or can be easily detected at the source side, and a preferred value for the parameter is advantageously determined for the time period corresponding to the shot.

Optionally, the processor may be further arranged for updating the preferred value of the parameter in dependence of a change of the region of interest exceeding a predetermined threshold, such as a substantial change of the depth position of a face.

Further preferred embodiments of devices and methods according to the invention are given in the appended claims, disclosure of which is incorporated herein by reference.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 shows a system for processing 3D video data and displaying the 3D video data,

FIG. 2 shows a method of processing a 3D video signal,

FIG. 3 shows a distribution of disparity values,

FIG. 4 shows a 3D signal,

FIG. 5 shows interleaved views for various offset values,

FIG. 6 shows a quality metric calculated for different values of an offset parameter,

FIG. 7 shows a system to determine an offset based on a sharpness metric,

FIG. 8 shows example depth map histograms, and

FIG. 9 shows scaling for adapting the view cone.

The figures are purely diagrammatic and not drawn to scale. In the Figures, elements which correspond to elements already described may have the same reference numerals.

### DETAILED DESCRIPTION OF EMBODIMENTS

There are many different ways in which 3D video signal may be formatted and transferred, according to a so-called a 3D video format. Some formats are based on using a 2D channel to also carry stereo information. In the 3D video signal the image is represented by image values in a two-dimensional array of pixels. For example the left and right view can be interlaced or can be placed side by side or top-bottom (above and under each other) in a frame. Also a depth map may be transferred, and possibly further 3D data like occlusion or transparency data. A disparity map, in this text, is also considered to be a type of depth map. The depth map has depth values also in a two-dimensional array corresponding to the image, although the depth map may have a resolution different from that of the “texture” input image(s) contained in the 3D signal. The 3D video data may be compressed according to compression methods known as such, e.g. MPEG. Any 3D video system, such as internet or a Blu-ray Disc (BD), may benefit from the proposed enhancements.

The 3D display can be a relatively small unit (e.g. a mobile phone), a large Stereo Display (STD) requiring shutter glasses, any stereoscopic display (STD), an advanced STD taking into account a variable baseline, an active STD that targets the L and R views to the viewers eyes based on head tracking, or an auto-stereoscopic multiview display (ASD), etc. Views need to be warped for said different types of displays, e.g. for ASD's and advanced STD's for variable baseline, based on the depth/disparity data in the 3D signal. When content is used that is not intended for playback on an autostereoscopic device, the disparity/depth in the image needs to be mapped onto a disparity range of the target display device, which is called targeting. However, due to targeting images may get blurred for certain parts and/or there is a relatively small depth effect.

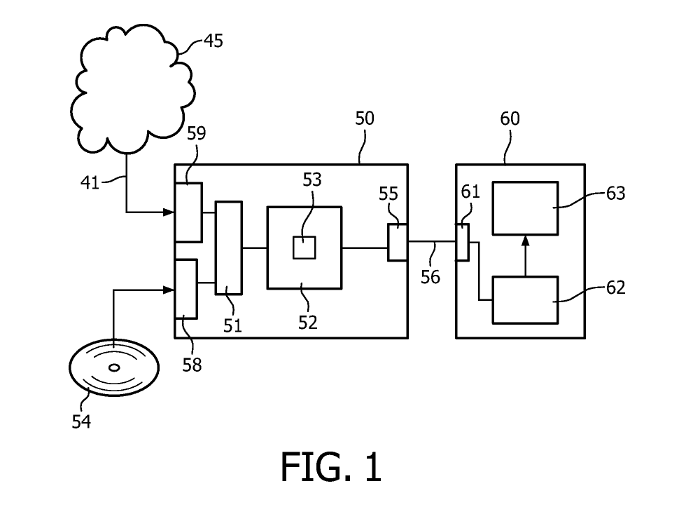

FIG. 1 shows a system for processing 3D video data and displaying the 3D video data. A 3D video signal 41 is provided to a 3D video device 50, which is coupled to a 3D display device 60 for transferring a 3D display signal 56. The 3D video signal may for example be a 3D TV broadcast signal such as a standard stereo transmission using ½ HD frame compatible, multi view coded (MVC) or frame compatible full resolution (e.g. FCFR as proposed by Dolby). Building upon a frame-compatible base layer, Dolby developed an enhancement layer to recreate the full resolution 3D images.

FIG. 1 further shows a record carrier 54 as a carrier of the 3D video signal. The record carrier is disc-shaped and has a track and a central hole. The track, constituted by a pattern of physically detectable marks, is arranged in accordance with a spiral or concentric pattern of turns constituting substantially parallel tracks on one or more information layers. The record carrier may be optically readable, called an optical disc, e.g. a DVD or BD (Blu-ray Disc). The information is embodied on the information layer by the optically detectable marks along the track, e.g. pits and lands. The track structure also comprises position information, e.g. headers and addresses, for indication the location of units of information, usually called information blocks. The record carrier 54 carries information representing digitally encoded 3D image data like video, for example encoded according to the MPEG2 or MPEG4 encoding system, in a predefined recording format like the DVD or BD format.

The 3D video device 50 has a receiver for receiving the 3D video signal 41, which receiver has one or more signal interface units and an input unit 51 for parsing the incoming video signal. For example, the receiver may include an optical disc unit 58 coupled to the input unit for retrieving the 3D video information from an optical record carrier 54 like a DVD or Blu-ray disc. Alternatively (or additionally), the receiver may include a network interface unit 59 for coupling to a network 45, for example the internet or a broadcast network, such device being a set-top box or a mobile computing device like a mobile phone or tablet computer. The 3D video signal may be retrieved from a remote website or media server. The 3D video device may be a converter that converts an image input signal to an image output signal having view targeting information, e.g. a preferred value for a parameter for targeting as described below. Such a converter may be used to convert input 3D video signals for a specific type of 3D display, for example standard 3D content to a video signal suitable for auto-stereoscopic displays of a particular type or vendor. The 3D display requires multiple views for creating a 3D effect for a viewer. In practice, the 3D video device may be a 3D enabled amplifier or receiver, a 3D optical disc player, or a satellite receiver or set top box, or any type of media player. Alternatively the 3D video device may be integrated in a multi-view ASD, such as a barrier or lenticular based ASD.

The 3D video device has a processor 52 coupled to the input unit 51 for processing the 3D information for generating a 3D display signal 56 to be transferred via an output interface unit 55 to the 3D display device, e.g. a display signal according to the HDMI standard, see “High Definition Multimedia Interface; Specification Version 1.4a of Mar. 4, 2010”, the 3D portion of which being available at http://hdmi.org/manufacturer/specification.aspx for public download.

The 3D display device 60 is for displaying the 3D image data. The device has an input interface unit 61 for receiving the 3D display signal 56 including the 3D video data and the view targeting information transferred from the 3D video device 50. The device has a view processor 62 for providing multiple views of the 3D video data based on the 3D video information. The views may be generated from the 3D image data using a 2D view at a known position and a depth map. The process of generating a view for a different 3D display eye position, based on using a view at a known position and a depth map is called warping of a view. The views are further adapted based on the view targeting parameter as discussed below. Alternatively the processor 52 in the 3D video device may be arranged to perform said view processing. Multiple views generated for the specified 3D display may be transferred with the 3D image signal towards said 3D display.

The 3D video device and the display may be combined into a single device. The functions of the processor 52 and the video processor 62, and remaining functions of output unit 55 and input unit 61, may be performed by a single processor unit. The functions of the processor are described now.

In operation, the processor determines a processed view based on at least one of the multiple views adapted by a parameter for targeting the multiple views to the 3D display. The parameter may for example be an offset, and/or a gain, applied to the views for targeting the views to the 3D display. Then the processor determines a combination of image values of the processed view that contains image data warped by disparity and image values of a further view, for example an image that is provided with the 3D video signal.

Subsequently, a quality metric is calculated indicative of perceived 3D image quality. The quality metric is based on the combination of image values. The process of determining the processed view and calculating the quality metric is repeated for multiple values of the parameter, and a preferred value for the parameter is determined based on the respective metrics.

When the quality metric is being calculated based on non-interleaved images, it is preferable to relate image information from the corresponding (x,y) position in the images. When the rendered image is not at the same spatial resolution, preferably one or both images are scaled so as to simplify the calculation of the quality metric in that then the same spatial (x,y) positions can be used. Alternatively the quality metric calculation can be adapted so as to handle the original unscaled images, but to relate the proper image information, e.g. by calculating one or more intermediate values that allow comparison of the non-interleaved images.

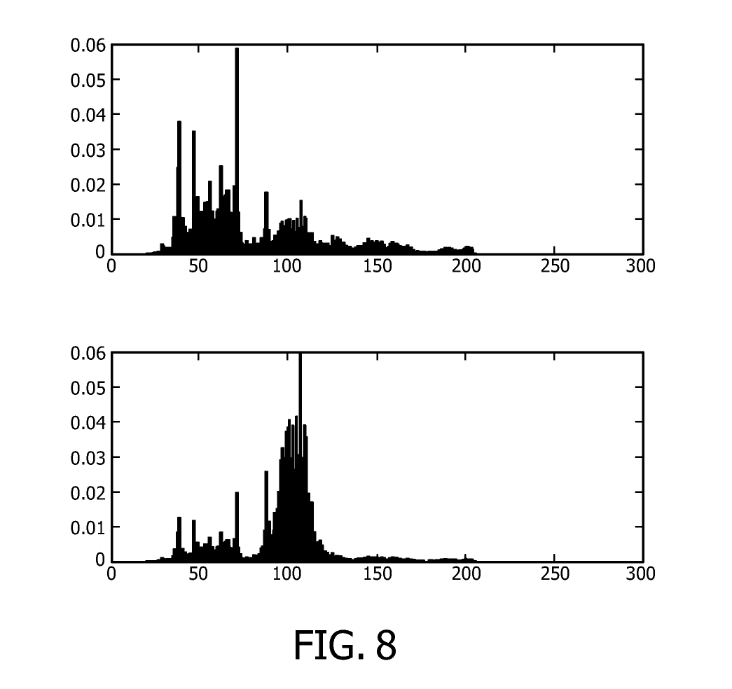

The parameter may also be a type of scaling, which indicates how the values in the depth map are to be translated into actual values to be used when warping the views, e.g. bi-linear scaling, bicubic scaling, or a predetermined type of non-linear scaling. For different types of scaling the quality metric is calculated, and a preference is determined. A further type of scaling refers to scaling the shape of the view cone, which is described below with reference to FIG. 8.

The further view in the combination of image values may be a further processed view based on the 3D image data adapted by the parameter. The further view represents a different viewing angle, and is processed by the same value of the parameter, e.g. offset. The quality metric now represents the perceived quality due to the differences between the processed views. The further view may be a 2D view available in the 3D image data. Now the processed view is compared to an original 2D view that has a high quality and no artifacts due to view warping.

Alternatively, the further view may be a further processed view based on the 3D image data adapted by the parameter and the processed view and the further processed view are interleaved to constitute the combination of image values. Now a single interleaved image contains the image values of the combination. For example, the processed view may correspond to an interleaved 3D image to be displayed on an array of pixels of an auto stereoscopic 3D display by interleaving the multiple views. The quality metric is calculated based on the interleaved image as such, e.g. by determining a sharpness of the interleaved image.

The processor may be arranged for determining at least a first view and a second view based on the 3D image data adapted by the parameter, and interleaving the at least first and second view to determine the processed view. The interleaved view is compared to the further view, e.g. a 2D image as provided in the 3D video signal to calculate the quality metric, e.g. based on a PSNR calculation.

The processor may be arranged for determining the processed view based on a leftmost and/or a rightmost view from a sequence of views extending from the leftmost view to the rightmost view. Such an extreme view does have the highest disparity, and therefore the quality metric will be affected substantially.

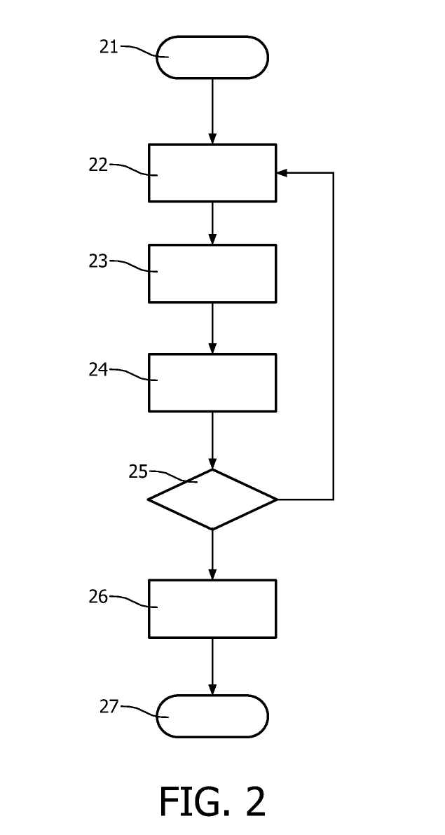

FIG. 2 shows a method of processing a 3D video signal. The 3D video signal contains at 3D image data to be displayed on a 3D display, which 3D display requires multiple views for creating a 3D effect for a viewer. Initially, at stage 21 RCV the method starts with receiving the 3D video signal. Next in stage SETPAR 22, a value is set for a parameter for targeting the multiple views to the 3D display, e.g. an offset parameter. Different values for the parameter are subsequently set for further iterations of the process. Next, at stage PVIEW 23, a processed view is determined based on at least one of the multiple views adapted by the actual value of the parameter, as described above. Next, at stage METR 24, a quality metric is calculated indicative of perceived 3D image quality. The quality metric is based on the combination of image values of the processed view and the further view. Next, at stage LOOP 25, it is decided whether further values of the parameter need to be evaluated. If so, the process continues at stage SETPAR 22. When sufficient values for the parameter have been evaluated, at stage PREF 26, a preferred value for the parameter is determined based on the multiple corresponding quality metrics acquired by the loops of said determining and calculating for multiple values of the parameter. For example, the parameter value may be selected that has the best value for the quality metric, or an interpolation may be performed on the quality metric values found to estimate an optimum, e.g. a maximum.

Effectively the repeated calculation provides a solution in which a mapping is used to render an image and subsequently an error measure/metric is established based on the rendered image (or part thereof) so as to establish an improved mapping. The error measure that is determined may be based on a processed view resulting from the interleaving of views. An alternative a processed view may be based on one or more views prior to interleaving, as described above.

The processing of 3D video may be used to convert content “off-line”, e.g. during recording or using a short video delay. For example the parameter may be determined for a period of a shot. Disparity at the start and end of a shot might be quite different. In spite of such differences the mapping within a shot needs to be continuous. Processing for periods may require shot-cut detection, off-line processing and/or buffering. Automatically detecting boundaries of a shot as such is known. Also the boundaries may already be marked or may be determined during a video editing process. For example an offset value that is determined for a close-up shot of a face, may be succeeded by a next offset value for a next shot of a remote landscape.

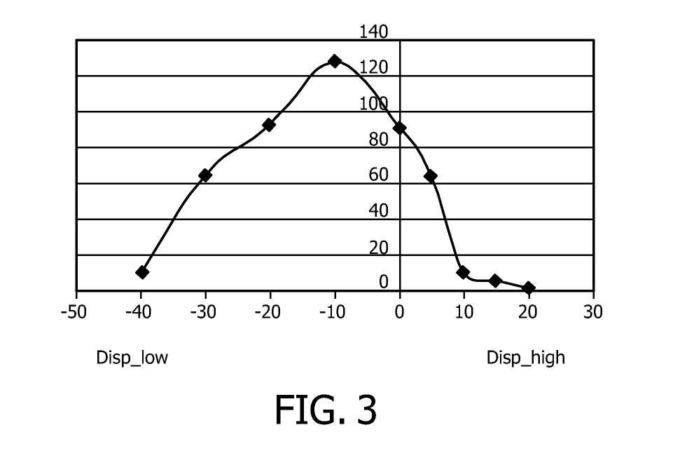

FIG. 3 shows a distribution of disparity values. The Figure shows a graph of disparity values from a 3D image. The disparities vary from a low disparity value Disp_low to high disparity value Disp_high and may have statistical distribution as shown in the figure. The example of distribution of disparities in the image content has a median or center of gravity at −10 pixels disparity. Such disparity range must be mapped to a depth map to support an auto-stereoscopic display. Traditionally, the disparities between Disp_low to Disp_high may be mapped linearly to depth 0 . . . 255. Low and high values can also be the 5% or 95% points of the distribution. The disparities may be determined for each shot using a shot detector. However linear mapping might lead to problems with asymmetric distributions. An alternative mapping might be to map the center of gravity of the distribution (i.e. −10 pixels in the example) to a depth value corresponding to ASD on-screen level (usually 128) and the disparity range linear around this on-screen depth level. However, such mapping often does not match with the visual perception when looking to the ASD. Often for some object close to the viewer (out of screen), or objects far from the viewer, an annoying blurring can be observed. The blurring is content dependent. An unattractive remedy to avoid the blurring, is to reduce the overall depth range (low gain), however this leads to less perceived depth on the ASD. Manual control is also unattractive.

In an embodiment the following processing is implemented. First a depth map is provided, for example by converting stereo to 2D and depth. Then an initial mapping is performed, using a first reasonable disparity to depth mapping, such as mapping the center of the distribution to the depth value corresponding to ASD screen level. Then a number of views are generated from this depth and 2D signal and then interleaved to create a processed view. The interleaved view may be coupled to the ASD display panel. The idea is to use the processed view as a 2D signal, and compare it with the original 2D signal. The process is repeated for a range of depth (or disparity) offset values. The comparison as such can be done by a known method such as spectrum analysis, FFT, etc, but can also be a more simple method such a SAD or PSNR calculation. The area for processing may be limited to a central area of the image by avoiding the border data, for example a border of 30 pixels wide for the horizontal and vertical borders.

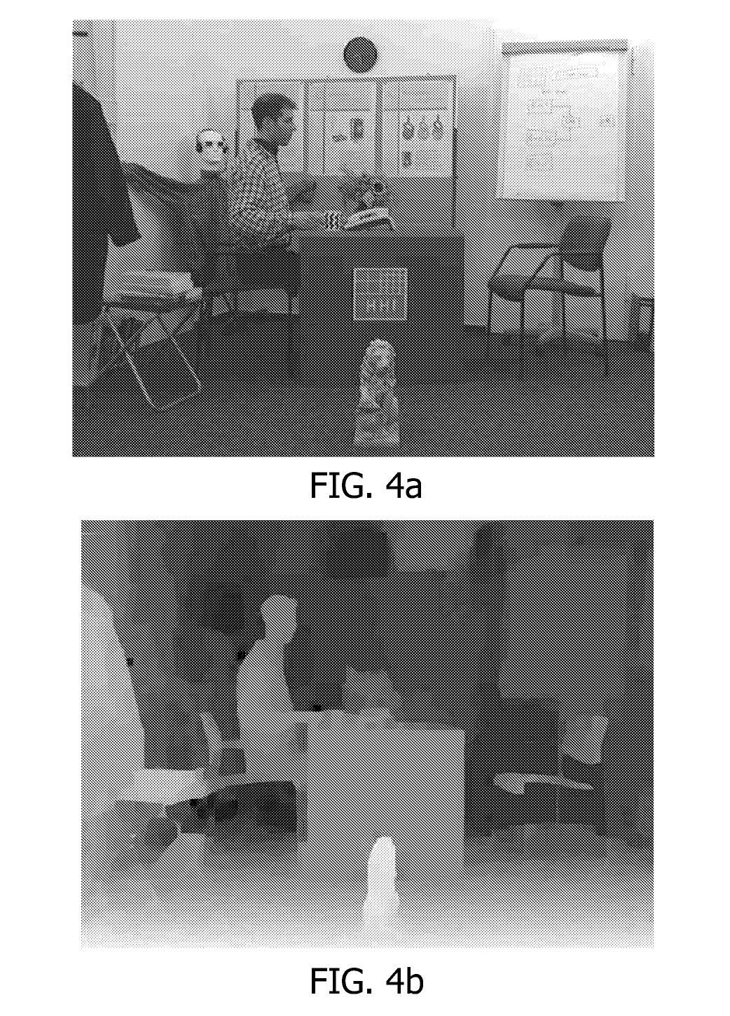

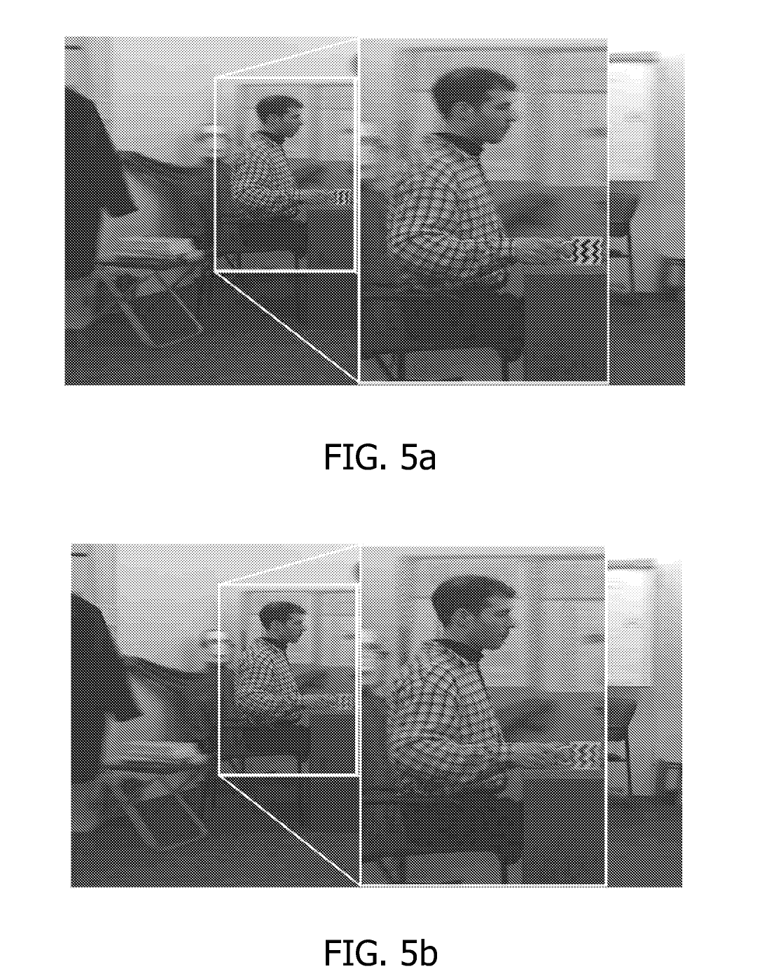

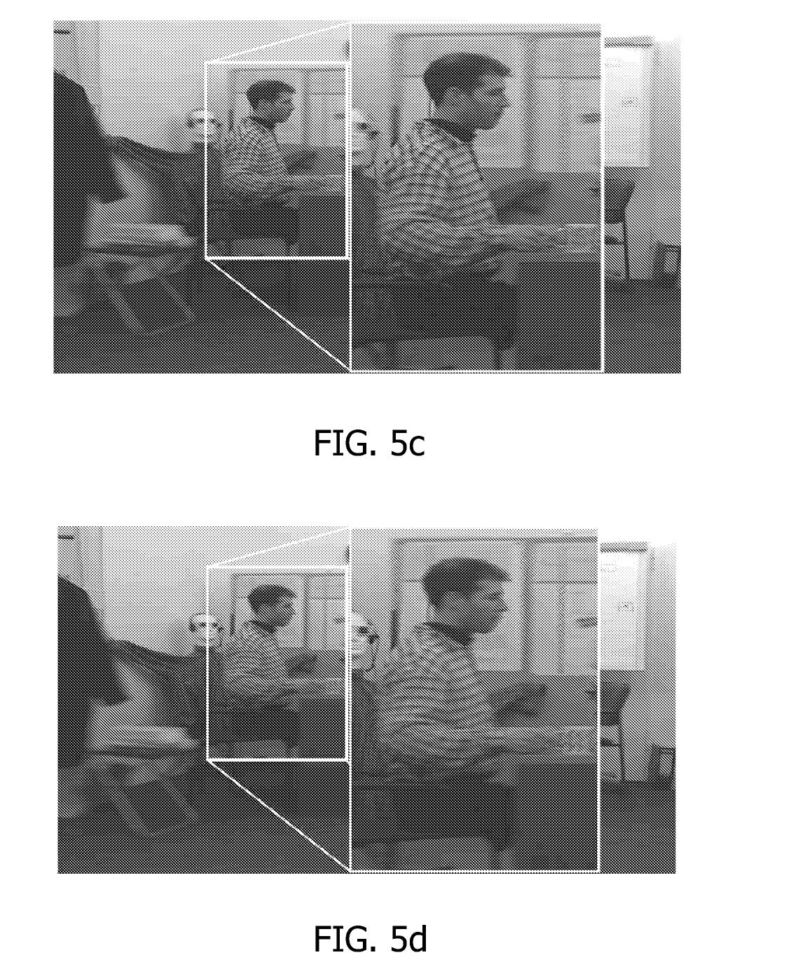

FIG. 4 shows a 3D signal. The 3D video signal comprises a 2D image and a corresponding depth map. FIG. 4a shows a 2D image, and FIG. 4b shows a corresponding depth map. The views for rendering on the 3D display are generated based on the 2D image and the depth map. Subsequently the views are interleaved to create an interleaved view. The interleaved view may be transferred to an LCD panel of an autostereoscopic display. The interleaved views for different values of offset are now used as the processed views to calculate the quality metric based on PSNR for the respective offsets, as illustrated by FIGS. 5 and 6.

The FIG. 5 were generated for a display panel having a 1920×1080 screen resolution wherein each pixel was composed of three RGB subpixels. The rendered images represent images that were rendered using different depth offset parameters; i.e. the depth level in the range of 0-255 that corresponds to zero-disparity on the display.

As a result of the difference in aspect ratio between the input image and that of the target device, the image is stretched along its horizontal axis. In order to better observe the differences between the respective images a section of the interleaved images has been enlarged. In order to calculate a PSNR quality metric the original input image (FIG. 4a) was scaled to 1920×1080. Subsequently the PSNR quality metrics were calculated for FIG. 5a-5d. The interleaved images were rendered for an ASD having a slanted lenticular applied. As a result of the interleaving process the sub-pixels of all 1920×1080 image pixels of the respective interleaved image comprise view information associated with three different views.

FIG. 5a-5d correspond with four different depth offset values; an offset of 110, 120, 130 and 140 respectively. Visually, the different offsets result in objects at different depths in the image being imaged more or less sharp as a result of the interleaving process and the different displacements (disparity) of image information in the rendered views. As a result the “crisp” zigzag pattern on the mug visible in FIG. 5a is blurred in FIG. 5b-d.

FIG. 5a shows the interleaved picture with offset=110. The quality metric is calculated based on PSNR with 2D picture, and is 25.76 dB.

FIG. 5b shows the interleaved picture with offset=120. The quality metric is calculated based on PSNR with 2D picture, and is 26.00 dB.

FIG. 5c shows the interleaved picture with offset=130. The quality metric is calculated based on PSNR with 2D picture, and is 25.91 dB.

FIG. 5d shows the interleaved picture with offset=140. The quality metric is calculated based on PSNR with 2D picture, and is 25.82 dB.

In the example illustrated by FIG. 5 the optimum offset parameter would be 120.

FIG. 6 shows a quality metric calculated for different values of an offset parameter. The Figure shows the quality metric values based on the PSNR as a function of the offset parameter value. From the curve in the Figure it can be seen that an offset value of 120 results in the maximum value of the quality metric. Verification by a human viewer confirmed that 120 indeed is the optimum value for the offset for this image.

It is noted that the method not only takes disparities into account, or just information from the 2D signal, but establishes a combined analysis. Due to the combined analysis, for example skies or clouds with little details but with large disparity values hardly contribute to the PSNR differences. This corresponds to perceived 3D image quality, since such objects at a somewhat blurred display position also hardly hamper the viewing experience. The processed view may be a virtual interleaved view, i.e. different from the actual ASD interleaved view, by using an interleaving scheme with less views, or just one extreme view.

In the device as shown in FIG. 1, the processor may be equipped as follows. The processor may have a unit for determining a region of interest in the processed view, and for calculating the quality metric by applying a weighting on differences of image values in the region of interest for displaying the region of interest in a preferred depth range of the 3D display. The parameter is determined so as to enable displaying the region of interest in a preferred depth range of the 3D display. Effectively, the region of interest is constituted by elements or objects in the 3D video material that are assumed to catch the viewer's attention. For example, the region of interest data may indicate an area of the image that has a lot of details which will probably get the attention of the viewer. The region of interest may be known or can be detected, or an indication may be available in the 3D video signal.

In the region of interest differences between the image values are weighted, e.g. objects that are intended to have more impact on perceived quality may be stressed to have more contribution to the quality metric. For example, the processor may have a face detector 53. A detected face may be used to determine the region of interest. Making use of the face detector, optionally in combination with the depth map, a weighting may be applied for areas with faces to the corresponding image value differences, e.g. 5 times the normal weight on the squared differences for the PSNR calculation. Also the weighting could be multiplied with the depth value or a value derived from the depth, e.g. a further weighting for faces at large depths (far out of screen), e.g. 10×, and weighting for faces at small depths (faces behind the screen) e.g. 4×.

Furthermore, the processor may be equipped for calculating the quality metric by applying a weighting on differences of image values in dependence on corresponding depth values. Selectively a weight depending on the depth may be applied to image differences while calculating the metric, for example weighting at large depth 2×, and weighting at small depths 1×. This relates to the perceived quality, because blurring in the foreground is more annoying than blurring in the background.

Optionally, a weight may be applied depending on the absolute difference of the depth and the depth value at screen level. For example a weighting at large depth differences of 2×, and weighting at small depths differences of 1×. This relates to the perceived quality, because the sensitivity of determining the optimal (minimum PSNR) offset level is increased.

In an embodiment the processor is equipped for calculating the quality metric based on processing along horizontal lines of the combination of image values. It is noted that disparity differences always occur in horizontal direction corresponding to the orientation of the eyes of viewers. Hence the quality metric may effectively be calculated in horizontal direction of the images. Such a one-dimensional calculation is less complex. Also the processor may be equipped for reducing the resolution of the combination of image values, for example by decimating the matrix of image values of the combination. Furthermore, the processor may be equipped for applying a subsampling pattern or random subsampling to the combination of image values. The subsampling pattern may be designed to take different pixels on adjacent lines, in order to avoid missing regular structures in the image content. Advantageously, the random subsampling achieves that structured patterns do still contribute to the calculated quality metric.

A system to automatically determine the offset for a 3D display may be based on using a sharpness metric. As such sharpness is an important parameter that influences the picture quality of 3D displays, especially auto-stereoscopic displays (ASD). The sharpness metric may be applied to the combination of image values as described above. The document “Local scale control for edge detection and blur estimation, by J. H. Elder and S. W. Zucker,” IEEE Transactions on Pattern Analysis and Machine Intelligence, vol. 20, no. 7, pp. 699-716, July 1998 describes a method to calculate a blur-radius for the edges in an image.

Alternatively, the system may be applied to an image with an accompanying depth map. The latter can e.g. be estimated from a stereo pair (left+right image), or transferred with the 3D video data. The idea of the system is to weigh the histogram of the depth map using the sharpness metric. Then the depth values corresponding to sharp (in focus) areas of the image will have a higher weight than un-sharp areas. As such the mean of the resulting histogram will bias towards the in-focus depth plane. As a sharpness metric, the inverse of the blur-radius may be used.

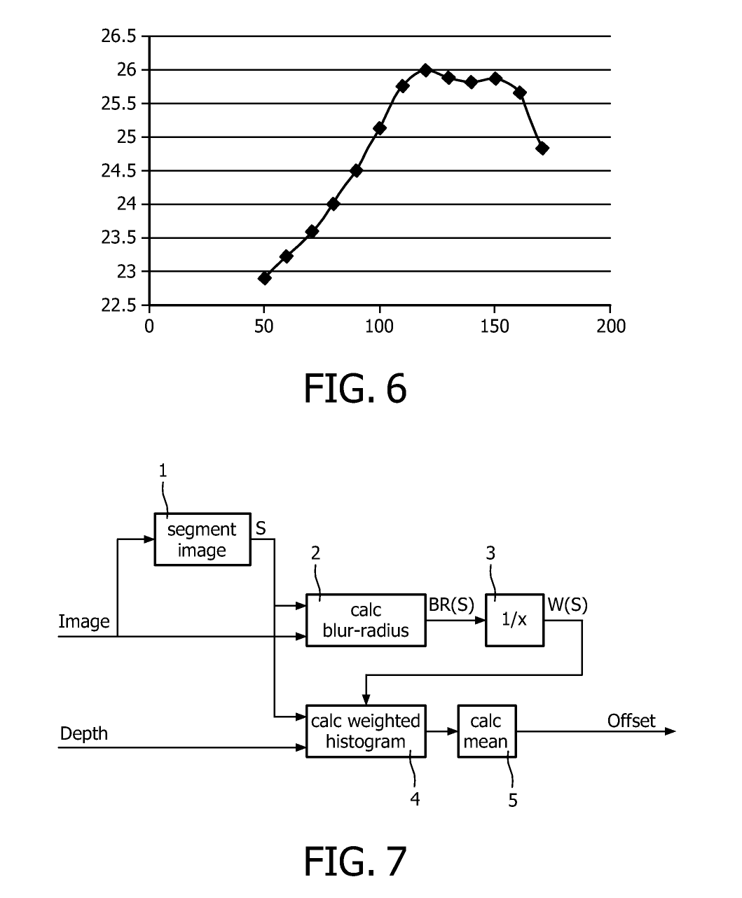

FIG. 7 shows a system to determine an offset based on a sharpness metric. A 3D signal having image and depth data is provided at the input. In a segmenting unit 61 a binary segmentation map S is calculated using i.e. edge detection. S now indicates pixels in the image where the blur-radius can be calculated. In a blur-radius calculator 62 the blur-radius BR(S) is calculated for the segmented input image. In an inverter 63 (denoted by 1/X) the reciprocal value of the blur radius is used for determining the sharpness metric W(S). In histogram calculator 64 a weighted histogram of the segmented depth-map is calculated. In this process, depth-values depth(S) are multiplied (weighted) with the sharpness metric W(S). In an average calculator 65 the mean of the histogram is calculated, which is now biased towards the focal plane (=optimal offset) of the input image. In such a system a processor would be arranged for calculating a sharpness metric for locations in the input image, determining depths at the locations, weighting the depths with the corresponding sharpness metric and determining a mean value of the weighted depths. The mean value may be shifted to a preferred sharpness value of the 3D display by applying a corresponding offset to the depths.

FIG. 8 shows example depth map histograms. The histograms shows depth values of an example picture. The depth map values are between 0-255. The image has a focal plane around depth=104, which depth would be an optimal offset for an ASD putting the sharp areas on-screen (zero-disparity). The upper graph 81 shows the original histogram of the depth map. The mean of this histogram is depth=86, which substantially deviates from the optimal value of depth=104. The lower graph 82 shows the weighted histogram using the sharpness metric. The mean of this histogram is depth=96, which is closer to the optimal value of depth=104.

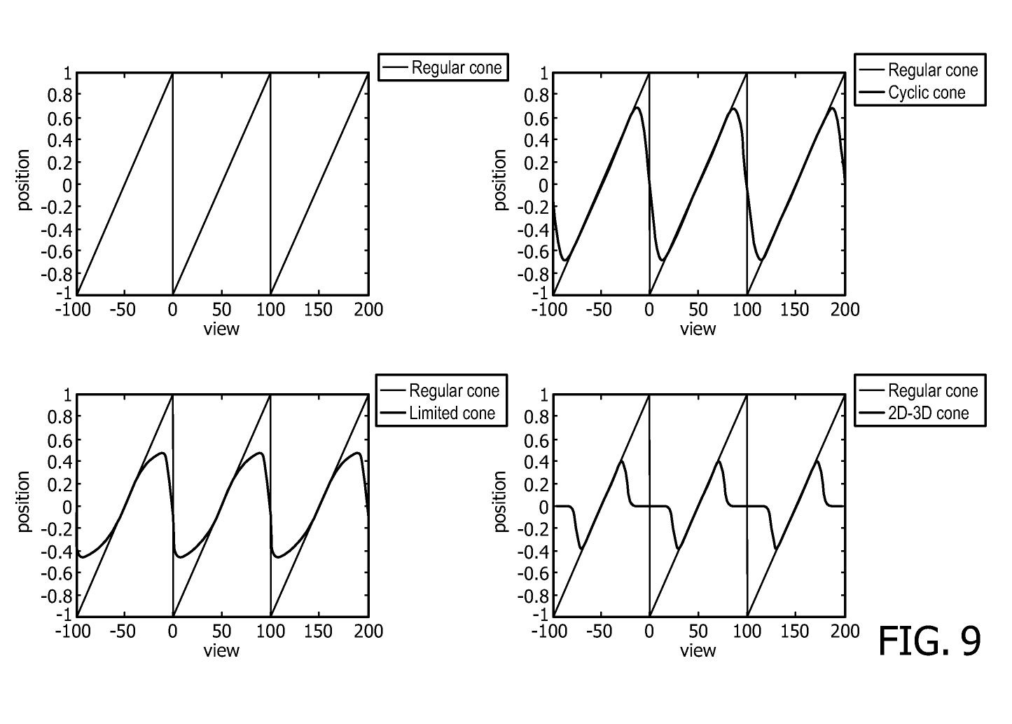

FIG. 9 shows scaling for adapting the view cone. The view cone refers to the sequence of warped views for a multiview 3D display. The type of scaling indicates the way the view cone is adapted compared to a regular cone in which each consecutive view has a same disparity difference with the preceding view. Altering the cone shape means changing the relative disparity of neighboring views by an amount less than said same disparity difference.

FIG. 9 top-left shows a regular cone shape. The regular cone shape 91 is commonly used in traditional multiview renderers. The shape has an equal amount of stereo for most of the cone and a sharp transition towards the next repetition of the cone. A user positioned in this transition area will perceive a large amount of crosstalk and inverse stereo. In the Figure a saw tooth shaped curve indicates the regular cone shape 91 having a disparity linearly related to its position in the cone. The position of the views within the viewing cone is defined to be zero for the cone center, −1 for entirely left and +1 for entirely right.

It should be understood that altering the cone shape changes only the rendering of content on the display (i.e. view synthesis, interleaving) and does not require physical adjustments to the display. By adapting the viewing cone artifacts may be reduced and a zone of reduced 3D effect may be created for accommodating humans that have no or limited stereo viewing ability, or prefer watching limited 3D or 2D video. The parameter for adapting the depths or the warping may be the type of scaling which is used for the 3D video material at the source side for altering the cone shape. For example a set of possible scaling cone shapes for adapting the view cone may be predefined and each shape may be given an index, whereas the actual index value is selected based on the quality metric as calculated for the set of shapes.

In the further three graphs of the Figure the second curve shows three examples of adapted cone shapes. The views on the second curve in each example have a reduced disparity difference with the neighboring views. The viewing cone shape is adapted to reduce the visibility of artifacts by reducing the maximum rendering position. At the center position the alternate cone shapes may have the same slope as the regular cone. Further away from the center, the cone shape is altered (in respect to the regular cone) to limit image warping.

FIG. 9 top-right shows a cyclic cone shape. The cyclic cone shape 92 is adapted to avoid the sharp transition by creating a bigger but less strong inverse stereo region.

FIG. 9 bottom-left shows a limited cone. The limited cone shape 93 is an example of a cone shape that limits the maximum rendering position to about 40% of the regular cone. When a user moves through the cone, he/she experiences a cycle of stereo, reduced stereo, inverse stereo and again reduced stereo.

FIG. 9 bottom-right shows a 2D-3D cone. The 2D-3D cone shape 94 also limits the maximum rendering position, but re-uses the outside part of the cone to offer a mono (2D) viewing experience. When a user moves through this cone, he/she experiences a cycle of stereo, inverse stereo, mono and again inverse stereo. This cone shape allows a group of people of which only some members prefer stereo over mono to watch a 3D movie.

In summary, the invention aims to provide a targeting method that aims to reduce the blur in the image resulting from the mapping. The standard process of creating an image for display on a multi-view (lenticular/barrier) display is to generate multiple views and to interleave these views, typically on pixel or subpixel level, so that the different views are placed under the lenticular in manner suitable for 3D display. It is proposed to use a processed view, e.g. the interleaved image, as a normal 2D image and compare it with a further view, e.g. the original 2D signal, for a range of values of a mapping parameter, such as offset, and calculate a quality metric. The comparison can be based on any method, such as spectrum analysis, or SAD and PSNR measurements. The analysis does not only take disparities into account but also takes into account the image content. That is, if an area of the image does not contribute to the stereoscopic effect due to the nature of the image content, then that particular area does not contribute substantially to the quality metric.

It is noted that the current invention may be used for any type of 3D image data, either still picture or moving video. 3D image data is assumed to be available as electronic, digitally encoded, data. The current invention relates to such image data and manipulates the image data in the digital domain.

The invention may be implemented in hardware and/or software, or in programmable components. For example a computer program product may implement the methods as described with reference to FIG. 2.

It will be appreciated that the above description for clarity has described embodiments of the invention with reference to different functional units and processors. However, it will be apparent that any suitable distribution of functionality between different functional units or processors may be used without deviating from the invention. For example, functionality illustrated to be performed by separate units, processors or controllers may be performed by the same processor or controllers. Hence, references to specific functional units are only to be seen as references to suitable means for providing the described functionality rather than indicative of a strict logical or physical structure or organization. The invention can be implemented in any suitable form including hardware, software, firmware or any combination of these.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software, and a processor may fulfill the function of one or more units, possibly in cooperation with hardware elements. Further, the invention is not limited to the embodiments, and the invention lies in each and every novel feature or combination of features described above or recited in mutually different dependent claims.

1. 3D video device for processing a three dimensional [3D] video signal, the 3D video signal comprising 3D image data to be displayed on a 3D display, which 3D display requires multiple views for creating a 3D effect for a viewer, the 3D video device comprising:
receiver for receiving the 3D video signal,
a processor for
determining at least one processed view based on the 3D image data adapted by a parameter for targeting the multiple views to the 3D display,
calculating a quality metric indicative of perceived 3D image quality, which quality metric is based on a combination of image values of the processed view and a further view, wherein further view is a further processed view based on the 3D image data adapted by the parameter, or the further view is a 2D view available in the 3D image data, or the further view is a further processed view based on the 3D image data adapted by the parameter and the processed view, and
determining a preferred value for the parameter based on performing said determining and calculating for multiple values of the parameter.

2. (canceled)

3. 3D video device as claimed in claim 1, wherein the processor is arranged for determining at least a first view and a second view based on the 3D image data adapted by the parameter, and interleaving the at least first and second view to determine the processed view, or the processor is arranged for determining the processed view based on a leftmost and/or a rightmost view, the multiple views forming a sequence of views extending from the leftmost view to the rightmost view.

4. 3D video device as claimed in claim 1, wherein the processor is arranged for calculating the quality metric based on a Peak Signal-to-Noise Ratio calculation on the combination of image values, or based on a sharpness calculation on the combination of image values.

5. 3D video device as claimed in claim 1, wherein the parameter for targeting the 3D video comprises at least one of:
an offset;
a gain;
a type of scaling.

6. 3D video device as claimed in claim 1, wherein the processor is arranged for calculating the quality metric based on a central area of the combination of image values by ignoring border zones, or for calculating the quality metric by applying a weighting on the combination of image values in dependence on corresponding depth values.

7. 3D video device as claimed in claim 1, wherein the processor is arranged for determining a region of interest in the processed view, and for calculating the quality metric by applying a weighting on the combination of image values in the region of interest for displaying the region of interest in a preferred depth range of the 3D display.

8. 3D video device as claimed in claim 7, wherein the processor comprises a face detector (53) for determining the region of interest.

9. 3D video device as claimed in claim 1, wherein the processor is arranged for calculating the quality metric for a period of time in dependence of a shot in the 3D video signal.

10. 3D video device as claimed in claim 1, wherein the processor is arranged for calculating the quality metric based on a subset of the combination of image values by at least one of:
processing along horizontal lines of the combination of image values;
reducing the resolution of the combination of image values;
applying a subsampling pattern or random subsampling to the combination of image values.

11. 3D video device as claimed in claim 1, wherein the receiver comprises a read unit for reading a record carrier for receiving the 3D video signal.

12. 3D video device as claimed in claim 1, wherein the device comprises:
a view processor for generating the multiple views of the 3D video data based on the 3D video signal and for targeting the multiple views to the 3D display in dependence of the preferred value of the parameter;
the 3D display for displaying the targeted multiple views.

13. Method of processing a three dimensional [3D] video signal, the 3D video signal comprising at least a first image to be displayed on a 3D display, which 3D display requires multiple views for creating a 3D effect for a viewer, the method comprising:
receiving the 3D video signal,
determining at least one processed view based on the 3D image data adapted by a parameter for targeting the multiple views to the 3D display,
calculating a quality metric indicative of perceived 3D image quality, which quality metric is based on a combination of image values of the processed view and a further view, wherein the further view is a further processed view based on the 3D image data adapted by the parameter, or the further view is a 2D view available in the 3D image data, or the further view is a further processed view based on the 3D image data adapted by the parameter and the processed view, and
determining a preferred value for the parameter based on performing said determining and calculating for multiple values of the parameter.

14. Method as claimed in claim 13, wherein the further view is a further processed view based on the 3D image data adapted by the parameter, or the further view is a 2D view available in the 3D image data, or the further view is a further processed view based on the 3D image data adapted by the parameter and the processed view and the further processed view are interleaved to constitute the combination of image values.

15. Computer program product for processing a three dimensional [3D] video signal, which program is operative to cause a processor to perform the respective steps of the method as claimed in claim 13.
